(19) United States
(12) Patent Application Publication
(10) Pub. No.: US 2006/0233492 A1
(43) Pub. Date: Oct. 19, 2006

(54) Optical beam combiner/concentrator

(75) Inventor: David Thomas Schaafsma, Fallbrook, CA (US)

Correspondence Address: David Schaafsma, 744 Stewart Canyon Rd., Fallbrook, CA, 92028, US

(73) Assignee: Applied Optical Materials, Fallbrook, CA (US)

(21) Appl. No.: 11/399,852

(22) Filed: Apr. 8, 2006

Related U.S. Application Data
(60) Provisional application No. 60/671,187, filed on Apr. 15, 2005.

(51) Int. Cl. G02B 6/34

(52) U.S. Cl. 385/37

(57) ABSTRACT

A non-imaging optical collecting and concentrating apparatus for use in i.e., optical communications, passive lighting, and solar power applications that is relatively immune from optical incidence angle(s) and therefore does not need to track the movement of the sun to efficiently collect and concentrate optical energy. The apparatus includes a non-planar support structure having a source-facing entrance and an energy-outputting exit. An interior surface of the structure includes a scattering, reflecting and/or diffractive medium such as a photonic bandgap structure to enhance the collection and concentration efficiency.

### CROSS REFERENCE TO RELATED APPLICATIONS

This application claims the benefit of U.S. Provisional Patent Application No. 60/671,187 filed Apr. 15, 2005.

### FIELD OF THE INVENTION

This invention relates generally to the fields of optics, lasers, fiber optics, and in particular to an apparatus that efficiently collects and combines incident optical beams of similar or dissimilar wavelength.

### BACKGROUND OF THE INVENTION

The efficient combination, or coupling, of optical beams such as those emitted by lasers is one of the most fundamental operations in optics. Beam combination has application in areas ranging, from laser radar to fiber optic communications to laser surgery.

The prior art has produced several methods for combining optical beams, most of which suffer some power division penalty, where only a fraction of each beam is coupled into the free space mode or waveguide which conducts the output beam. A simple example is a half-silvered mirror, where as much as 50% of each of two beams can be combined, or overlapped, into a single beam pointing in a given direction.

In optical fibers, fused couplers are often used, and variants of these known as wavelength division multiplexers (WDMs) can allow efficient coupling of well over 90% of two beams on separate fibers, provided that the beams are of different wavelengths. The manufacture of fused couplers with controlled interference between the modes of the two arms of the coupler is well known in the literature and in practice. Other variants have been illustrated in works such as U.S. Pat. No. 4,725,131 by Goodwin et al, issued Feb. 16, 1988, which illustrates a method for making a star coupler from tapered waveguides with controlled interference to efficiently combine light from multiple ports into a single output port at a specific wavelength. Another such example is U.S. Pat. No. 4,863,231 by Byron et al, issued Sep. 5, 1989, which teaches a method for making a multiple-fiber beam expander using optically-amplifying fiber to make up for power division losses.

Another well known class of beam combining devices is that consisting of polarization-based methods. Typically, beams of different (often orthogonal) polarizations are overlapped spatially using reflective or refractive elements that discriminate on the basis of polarization state. While the technique itself is very well known in the field of optics, more recent variations on this approach include the variable coupling approach described by Scheps in U.S. Pat. No. 6,259,560, issued Jul. 10, 2001, wherein beams are combined using polarizing beamsplitters and rotated to orthogonal polarizations using half wave plates. A similar approach is that of Boye et al, described in U.S. Pat. No. 6,404,958 of Jun. 11, 2002, where beams from multiple fibers are combined by rotating polarization to reflect between parallel plates until an output aperture is reached.

The history of optical concentrators also includes many examples of reflective geometric devices such as cones and parabolic concentrators. An example is U.S. Pat. No. 6,244,264 issued to R. Winston on Jun. 12, 2001, which describes a single-axis parabolic reflector which can be used to concentrate sunlight onto a long pipe or heating element. A symmetrical conical reflective concentrator was described by Clegg in U.S Pat. No. 4,325,612 on Apr. 20, 1982. Jannson et al propose a modified design of the basic conic concentrator in U.S. Pat. No. 4,898,450 of Feb. 6, 1990, using a collimator to expand an input beam and a concentrator to re-image it onto the output fiber.

In the class of diffractive devices, which most closely relate to the present invention, the prior art is limited. In U.S. Pat. No. 4,682,841 (Jul. 28, 1987), Afian et al describe a means for using multiple concentrating facets, which may be made using holographic lenses, to focus multiple beams to a coincident spot. The system of Ljung et al (U.S. Pat. No. 4,865,452, Sep. 12, 1989) uses total internal reflection in prisms and tilted planar diffraction gratings to combine beams incident on a ring gyroscope. Ludman et al (U.S. Pat. No. 4,387,955, Jun. 14, 1983) describe a system using a curved grating to both focus and spectrally demultiplex a beam from a single fiber onto multiple fibers.

Yet another class of devices uses diffractive effects in waveguides to achieve beam separation or combination. The distributed Bragg reflector (DBR) has been known to experts in diode laser manufacture for decades; similar effects have been used to separate or combine multiple wavelengths, such as described in U.S. Pat. No. 6,137,933 issued Oct. 24, 2000 to Hunter et al, in which a planar grating is used in conjunction with a gradient-index optic to direct beams of different wavelengths to a common spot or to separate overlapping beams of different wavelengths to distinct focal points. Another common use of diffractive optics is in coupling beams out of or into waveguides, as exemplified in U.S. Pat. No. 6,999,660 (Feb. 14, 2006) by Park et al.

Despite these developments however, there exists a continuing need for optical collecting and concentrating structures providing high efficiency, low loss, and conversion of larger numerical aperture to smaller. Such structures would represent a significant advance in the art.

As known from the so-called Lagrange invariant of geometric optics, the conservation of optical path between two media C₁ and C₂ with boundary K is governed by

$${\int }_{{C}_{1}} {n}_{1} {s}_{1} \cdot ⅆ r + {\int }_{{C}_{2}} {n}_{2} {s}_{2} \cdot ⅆ r + {\int }_{K} ( {n}_{2} {s}_{2} - {n}_{1} {s}_{1} ) \cdot ⅆ r = 0 , \qquad ( 1 )$$

where n is the refractive index, and s is the ray vector. The throughput, or the product of angular acceptance and optical aperture, in a non-diffractive optical system is limited by the component with the smallest throughput, so that

$${\int }_{{C}_{1}} {n}_{1} {s}_{1} \cdot ⅆ r + {\int }_{{C}_{2}} {n}_{2} {s}_{2} \cdot ⅆ r = 0. \qquad ( 2 )$$

This formulation is equivalent to the so-called Liouville form of non-imaging optics, wherein conservation of refractive and reflective systems is often expressed as
n₁d₁ sin α=n₂d₂ sin β, (3)
where n₁ and n₂ are the refractive indices of the media on either side of the system, d₁ and d₂ are the entrance and exit aperture widths of the system, respectively, and α and β are the angles over which the input and output beams are distributed. Diffractive optics provide the only means by which this constraint may be relaxed to allow larger angles and areas to be converted to smaller angles and areas, or a larger mode distribution to be condensed into a smaller distribution of degenerate modes.

As is known from the theory of diffraction gratings, many different approaches in the design of the surface parameters or index variation can be used to achieve specified goals. One such example concerns anti-reflection gratings, where various designs have been developed to reduce the specular reflection to negligible levels. These approaches have also been adapted for higher symmetry, with some biomimetic inspiration, to achieve recent developments such as “moth eye” coatings which have very low specular reflection over a very wide range of viewing angles.

### SUMMARY OF THE INVENTION

I have developed, in accordance with the principles of the invention, an optical combining and concentrating apparatus for use in i.e., optical communications, laser surgery, and laser radar applications. In sharp contrast to prior art devices, my inventive collector and concentrator is a non-imaging device and features high axial symmetry and efficient conversion of numerical aperture (NA). Consequently it can be used to combine multiple parallel beams into a single collinear one with low NA, useful in efficiently coupling the energy from many optical fibers into a single fiber, for example.

### BRIEF DESCRIPTION OF THE DRAWINGS

A more complete understanding of the present invention may be realized by reference to the accompanying drawing in which:

FIG. 1 shows a perspective view of an optical combination and concentration device constructed according to the teachings of the present invention;

FIG. 2 shows a detailed drawing of the diffractive process used in the tubular structure;

FIG. 3 shows the convention for positive and negative diffraction used herein; and

FIG. 4 shows one possible means to optimize a diffractive tube to more efficiently collimate light output.

### DETAILED DESCRIPTION

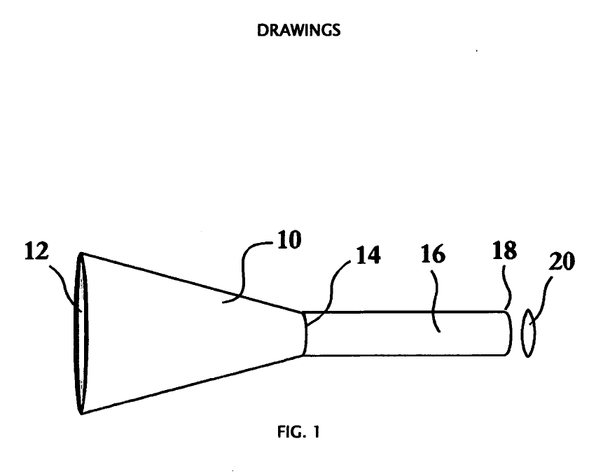

FIG. 1 shows a perspective view of a passive optical collection system constructed according to the present invention. More specifically, beams are incident on collector cone 10, with an entrance aperture 12, which reflects or diffracts rays to an aperture 14 at the opposite end of the cone. The cone may be either hollow or filled with a uniformly transparent medium. Abutting the exit aperture 14 is a tube 16, either hollow or filled with a uniformly transparent medium. Light emerges from the tube 16 at an exit aperture 18. Past the exit 18 of the tube 16 may be a lens 20 to capture light exiting the tube, e.g. for imaging onto a collector or into a fiber. Alternately, the coupler or fiber may be abutted directly to the exit 18 of the tube 16.

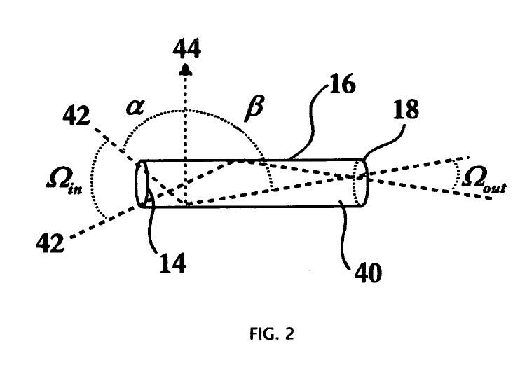

As shown in FIG. 2, the interior of the tube 16 is a diffractive medium 40, such that rays 42 striking the interior of the tube at an angle α with respect to the surface normal 44 are at least partially diffracted at a higher angle β. This diffractive effect is accumulated along the length of the tube, so that the total angular spread of rays Ωᵢₙ entering the tube is greater than the angular spread of rays Ωₒᵤₜ exiting the tube. In optical terms, the diffractive interior of the tube translates a larger input numerical aperture to a smaller output numerical aperture.

Several variations of this basic concept are also encompassed within the present invention, including conic concentrators with non-linear sides (e.g. parabolic, hyperbolic, exponential, power series) and combinations of lenses and cone concentrators as described above. When multiple sources are input to the cone substantially parallel to the cone axis (within an angular deviation comparable to the cone opening angle θ), reflective coatings may be used to reduce losses. If other sources are input at higher angles relative to the cone axis, it will be advantageous to make the sides of the cone diffractive in order to capture these rays. In all cases, the tube must be designed to translate a large range of input angles to a smaller range of output angles.

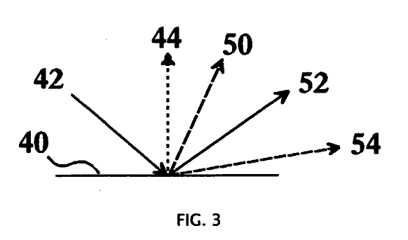

It will be apparent to skilled technicians that the diffraction grating 40 must be optimized to reduce negative diffraction, or diffraction of rays 50 in a direction proximal of the specular ray 52 with respect to the incident ray 42, as shown in FIG. 3. Equivalently, the desired diffractive effect is a positive one, where diffracted rays 54 are directed along an angle greater than the specularly reflected ray 52. Proper grating design to maximize positive diffraction will in many cases also have the effect of directing scattered light substantially more toward the output of the tube rather than the input.

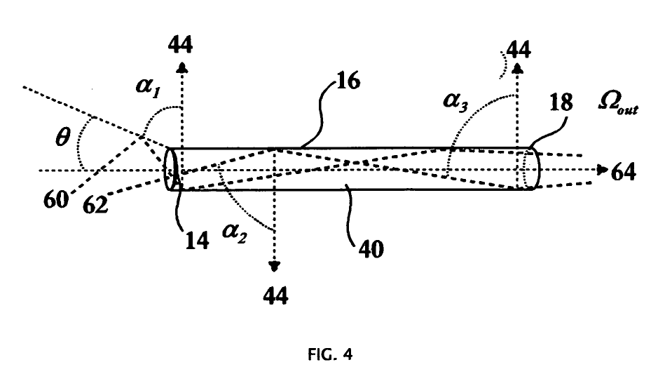

Several grating design variations may also be used to optimize the multiple diffraction effect. In particular, rays 60 striking the tube near the entrance 14 will be incident at angles slightly greater than the cone angle θ, as illustrated in FIG. 4. This maximum angle α₁ will depend not only on the configuration of the cone but of the input beams coupled into the tube by it. As a simple example, if the cone is straight-sided, reflective, and all the beams are parallel to the cone axis and can reach the exit aperture within N reflections, then α₁=π/2−Nθ. This also preserves the numerical aperture limitation of a reflective concentrator which can be expressed as N<π/2θ.

The angular output limit of the concentrator means that the grating can be optimized to diffract efficiently at angles greater than α₁, relative to the surface normal 44, near the entrance of the tube 14. An example of such optimization might be to use second order diffraction for incident angles α>α₁, since the second order is more efficient than the first at high incident angles for many grating designs, and lower than the first (often zero) at low incident angles. Rays 62 striking the surface farther down the tube will be incident at even higher angles α₂, relative to the surface normal 44, so that the optimal grating response will be designed to diffract more efficiently at more oblique angles α>α₂. Specular reflection, which will be limited to the angular range α₁<α<π/2 throughout the tube, may again be compensated using a design approach such as the second order grating method described above. Since the angle of the surface normal 44 relative to the axis of the tube 64 determines the diffracted angle at which rays will emerge from the tube, it is a preferred embodiment that the tube be straight, or that the surface normal 44 be perpendicular to the tube axis 64. However, this is not the only embodiment covered in the present invention. Those skilled in the art will appreciate that some refinements are possible in select cases, such as tilting the surface normal 44 toward the exit 18 of the tube 14.

Likewise, the length and width of the tube can be optimized for given materials and geometries. As is known from the technology of hollow waveguides, longer tubes will result in greater interaction of the light with the sides of the tube, or a greater number of reflections or diffractions and thus greater loss. At the same time, the multiple diffraction effect will require a certain number of diffraction events in order to confine a given percentage of incident beams into a cone of a given output angle (NA).

Further advantage in some applications may be gained by placing a lens near the output of the tube, so as to either focus or collimate the output light. In like fashion, the tube may have an elliptical, square, round, hexagonal, or other closed geometry cross section, and the cone may have similar cross-sectional shape. It is an object of the present invention to include all such permutations in the scope of this invention.

At this point, while I have discussed and described my invention using some specific examples, those skilled in the art will recognize that my teachings are not so limited. Accordingly, my invention should be only limited by the scope of the claims attached hereto.

What is claimed is:

1. An apparatus for combining optical radiation comprising:
a curved support structure, either hollow or filled, defining an entrance aperture, an exit aperture, and an interior surface, which may be reflecting or diffracting; and
a tube structure, either hollow or filled, lined with a diffractive medium, placed adjacent to the exit of the curved support structure;
such that light rays striking the interior of the curved support structure are directed to the exit aperture of the curved support structure, and thereby into the tube structure, whereupon the rays are diffracted from the surface of the tube structure, so that the radiation leaving the tube has both a smaller angular deviation than the radiation entering the tube structure, and covers an area smaller than the area of the said entrance aperture to the curved support structure.

2. The apparatus of claim 1, where the diffractive surface of the tube is made from a surface relief grating.

3. The optical apparatus of claim 2, wherein the surface relief grating is designed to diffract principally in a direction away from the specular reflection from the surface.

4. The optical apparatus of claim 3, where the surface grating uses any combination of triangular, sinusoidal, step width, or step height variations to achieve the desired diffraction characteristic.

5. The optical apparatus of claim 1, where the diffractive surface of the tube is made from a volume hologram or other periodic refractive index structure.

6. The apparatus of claim 1, where the diffractive surface of the tube is made from a photonic bandgap, moth-eye, or other subwavelength, periodic, or quasi-periodic, diffractive or preferentially scattering structure.

7. The optical apparatus of claim 1 wherein the curved support structure is one selected from the group consisting of: a conic parabolic concentrator (CPC), a simple power series concentrator including cubic, quartic, or quintic; a conic exponential concentrator (CEC), a conical shaped concentrator, a straight cone shaped concentrator, a bulb-shaped concentrator, and mixed-geometry shaped concentrators.

8. The optical apparatus of claim 1, wherein the tubular structure has a cross-sectional shape selected from the group consisting of: an elliptical, square, round, hexagonal, or other closed geometry cross section.

9. The optical apparatus of claim 1 further comprising a lens or transmission grating, placed at the distal end of the tubular structure where light rays exit the structure.

10. A method of combining optical energy comprising the steps of:
receiving the optical energy on a substantially non-planar structure having a reflecting or diffractive surface for receiving the optical energy and directing it to an aperture;
diffracting the optical energy through a tubular structure such that the output rays are directed substantially more parallel to the axis of the tubular structure; and
collecting the optical energy into a collector positioned at the collecting point.

11. The method of claim 10, where the diffractive surface of the tube is made from a surface relief grating.

12. The method of claim 11, wherein the surface relief grating is designed to diffract principally in a direction away from the specular reflection from the surface.

13. The method of claim 12, where the surface grating uses any combination of triangular, sinusoidal, step width, or step height variations to achieve the desired diffraction characteristic.

14. The method of claim 10, where the diffractive surface of the tube is made from a volume hologram or other periodic refractive index structure.

15. The method of claim 10, where the diffractive surface of the tube is made from a photonic bandgap, moth-eye, or other subwavelength, periodic, or quasi-periodic, diffractive or preferentially scattering structure.

16. The method of claim 10 wherein the curved support structure is one selected from the group consisting of: a conic parabolic concentrator (CPC), a simple power series concentrator including cubic, quartic, or quintic; a conic exponential concentrator (CEC), a conical shaped concentrator, a straight cone shaped concentrator, a bulb shaped concentrator, and a mixed-geometry shaped concentrator and the interior profile of the scattering medium may be chosen from a similar group.

17. The method of claim 10, wherein the tubular structure has a cross-sectional shape selected from the group consisting of: an elliptical, square, round, hexagonal, or other closed geometry cross section.

18. An optical combiner/concentrator comprising:
a curved means for supporting a reflective or diffractive surface wherein said curved supporting means defines an entrance aperture, an exit aperture, and an interior surface, wherein light rays incident through the entrance aperture are directed substantially toward the exit aperture; and
a means for collecting light rays at the exit aperture of the curved support structure into a tubular structure which preferentially directs light rays, at angles substantially more parallel with the axis of the tube, toward the opposite end of the tube;
such that light rays striking the interior surface of the curved support means are directed to exit aperture of the curve support structure and thereby into the tubular structure, whereupon the rays are diffracted from the surface of the tubular structure, so that the radiation leaving the tubular structure has both a smaller angular deviation than the radiation entering the tubular structure, and covers an area smaller than the area of the said entrance aperture to the curved support structure.
